(19) United States
(12) Patent Application Publication
(10) Pub. No.: US 2005/0120299 A1
(43) Pub. Date: Jun. 2, 2005

(54) System and method for creation of a network server application page

(75) Inventors: Brendan P. Murray, Monasterboice (IE); Stanley K. Jerrard-Dunne, Dublin (IE)

Correspondence Address: KUDIRKA & JOBSE, LLP, ONE STATE STREET, SUITE 800, BOSTON, MA, 02109, US

(73) Assignee: International Business Machines Corporation, Cambridge, MA (US)

(21) Appl. No.: 10/753,748

(22) Filed: Jan. 8, 2004

(30) Foreign Application Priority Data
Nov. 28, 2003 (GB) 0327665.6

(51) Int. Cl. G06F 15/00; G06F 17/21

(52) U.S. Cl. 715/513

(57) ABSTRACT

A system and method for creation of a network server application page where objects containing custom tags in a JAVA server page (JSP) are aggregated by input (32), process (34) and output (36) stages. The input stage involves arranging information into a structure having a number of elements with each element having a number of sub-elements. The process stage involves forming a template to represent each element type, the template having a marker, such that when the structure that represents the input is traversed, a corresponding template is matched with corresponding element values. The matching element values are substituted into the template text where the marker indicates, and the template content is appended to the output. The output is a ‘complex JSP page’, an aggregation of template content based on the structure representation of the input, which without this method of using templates would be very difficult to build.

### FIELD OF THE INVENTION

This invention relates to creation of network server application pages, and particularly, though not exclusively, to such server page creation in ‘JAVA™ 2 Platform, Enterprise Edition’ (J2EET).

### BACKGROUND OF THE INVENTION

In the field of this invention the use of custom tag libraries to access custom discrete functionality from within a J2EE application is increasing rapidly. Many of these tag libraries are extremely complex and exceedingly cumbersome to use. For example, constructing a complex JSP page having multiple tags wherein the cumulative effect of the tags represent a complicated structure such as a hierarchy of different objects is difficult to achieve.

From patent publication EP1126681 there is known the use of nested tags in JAVA™ Server Page (JSP™) pages. EP1126681 concerns formatting pages to support different devices using templates as a form for a style sheet. However, the approach taken in EP1126681 has the disadvantage that a complex JSP page remains relatively difficult to build.

A need therefore exists for a system and method for the creation of complex network server application pages wherein the abovementioned disadvantages may be alleviated.

### STATEMENT OF INVENTION

In accordance with a first aspect of the present invention there is provided a system for creation of a network server application page comprising means for representing information in a structure having at least one element, each element having at least one sub-element, means for processing a template representing each element and sub-element, the template having a marker, the means for processing for searching the structure for a corresponding template that matches the marker in the template, and substituting into the template an element value where the marker indicates, and means for aggregating the template based on the structure.

In accordance with a second aspect of the present invention there is provided a method for creation of a network server application page comprising representing information in a structure having at least one element, each element having at least one sub-element, processing a template representing each element and sub-element, the template having a marker, searching the structure for finding a corresponding template that matches the marker in the template, substituting into the template an element value where the marker indicates, and aggregating the template based on the structure to form the network server application page.

In accordance with a third aspect of the present invention there is provided a computer program product for creation of a network server application page for creating a network application page comprising a computer useable medium having a computer readable program code means embodied in the medium for causing creation of a network server application page, the computer program product comprising a computer readable program code means for representing information in a structure having at least one element, each element having at least one sub-element, a computer readable program code means for processing a template representing each element and sub-element, the template having a marker, a computer readable program code means for searching the structure for a corresponding template that matches the marker in the template, a computer readable program code means for substituting into the template an element value where the marker indicates, and a computer readable program code means for aggregating the template based on the structure to form the network server application page.

In accordance with a fourth aspect of the present invention there is provided a computer programmed to perform a method of creating a network server application page, the method comprising representing information in a structure having at least one element, each element having at least one sub-element, processing a template representing each element and sub-element, the template having a marker, searching the structure for a corresponding template that matches the marker in the template, substituting into the template an element value where the marker indicates, and aggregating the template based on the structure to form the network server application page.

### BRIEF DESCRIPTION OF THE DRAWINGS

One system and method for aggregation for creation of objects containing custom tags in a network server application page incorporating the present invention will now be described, by way of example only, with reference to the accompanying drawings, in which:

FIG. 1 shows a block diagram of a system in which an embodiment of the invention may be implemented;

FIG. 2 shows a screenshot of a screen display on a user's screen display of a user device in accordance with an embodiment of the invention;

FIG. 3 shows a screenshot of a screen display on a user's screen display of a user device in accordance with an embodiment of the invention; and

FIG. 4 shows a flow chart of a method in accordance with an embodiment of the invention.

### DESCRIPTION OF PREFERRED EMBODIMENTS

An embodiment of the invention is a mechanism to resolve the complexity associated with tag libraries as used in network server application pages, such as in JAVA™ server page (JSP™), and to simplify the use of tag libraries by cascading or nesting templates to aggregate the custom tags and apply standardised behaviors and attributes to the tags. The templates are interpreted by a tool such as an integrated development environment (IDE) such as IBM™ WEBSPHERE™ Studio Site Designer (WSSD), IBM WEBSPHERE Studio Application Developer, or the like that may be associated with the web-authoring environment. Such tools may be used to implement an embodiment by causing the insertion of complicated structures of custom tags which may be edited manually if so required. A complex JSP page is, for example, a page that may be constructed to have multiple tags, and the tags may have multiple parameters, wherein the cumulative effect of the tags represent a complicated structure such as a hierarchy of different objects.

Another example of an network server application page like JSP is an active server page (ASP) which is a hyper-text markup language (HTML) page that includes one or more scripts (small embedded programs) that are processed on a web server prior to the page being sent to the user. ASP, similar to a server-side include or a common gateway interface (CGI) application in that all involve programs that run on the server, usually tailors a page for the user. Typically, the script in the web page at the server uses input received as the result of the user's request for the page to access data from a database and then builds or customizes the page on the fly before sending the page to the user or requester.

An embodiment may be implemented in a system such as the computer device 2 and network system 1 shown in FIG. 1. The user device 2 allows a user to create complex JSP pages 12 via a web-authoring environment application 14. The user device may be any computer device, such as a laptop, desktop, personal digital assistant (PDA), or the like, that may access and communicate to a network 4 and provide a web-authoring environment. Such user device may include a central processing unit 8 to control communication within the user device between a memory 10, the application 14 and complex JSP page 12, and an input/output (I/O) and network interface 6. The I/O-network interface may support peripheral devices 16 such as a screen display, and the like. The network 4 may be the internet, enterprise network, combination, or the like. The user device 2 may allow a user to design a complex JSP page 12, and apply the page via the network and a server device 3 having a network interface 7, processor 9, memory 11 for storing items 13 such as documents, information, such as JSP pages and the like. Web pages 5 are also accessible by the server and user device via the network.

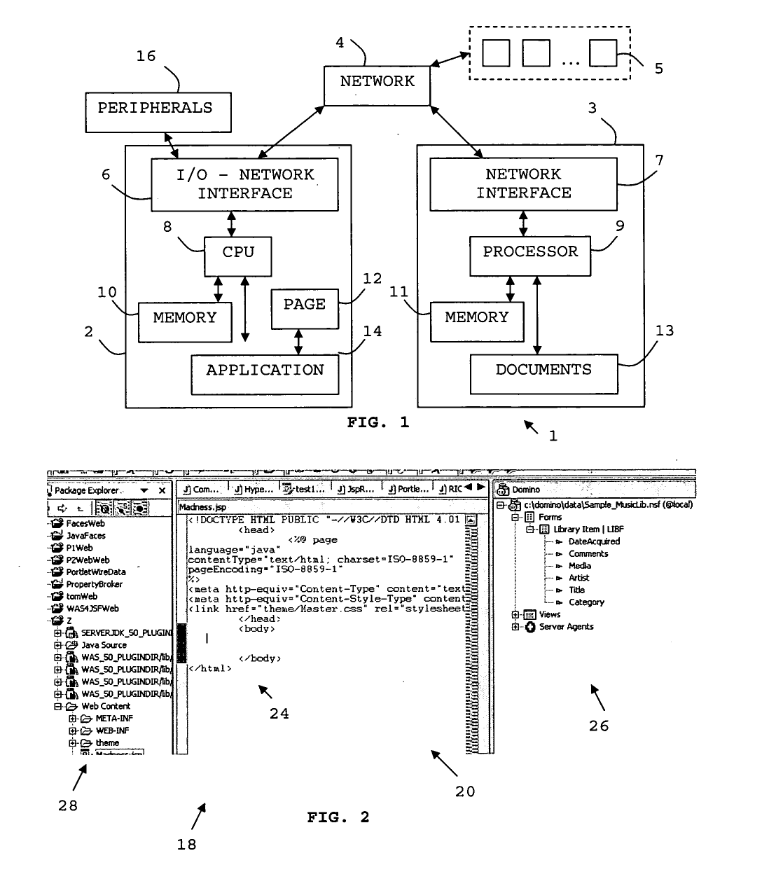

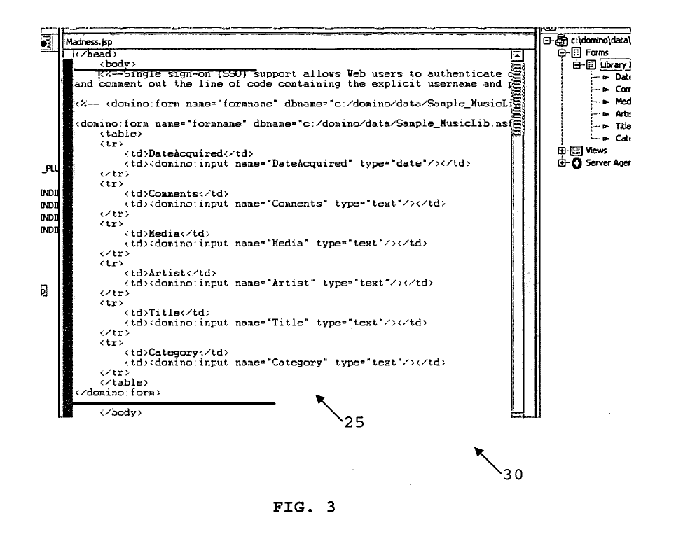

An example of a graphical user interface implementing the mechanism is shown in FIG. 2. FIG. 2 shows a screenshot 18 of a screen display 16 on a user's screen display 16 of a user device 2. The user device shown provides a web-authoring environment, for example an IDE such as WSSD or the like as discussed above. The screenshot 18 is a graphical representation of a JSP page editor 20 in the mid-window of the screen together with navigator window 28 in the left-window of the screen listing a number of projects and files contained within the projects, and a database 26 such as IBM LOTUS™ DOMINO™ (DOMINO) database in the right-window of the screen. WSSD includes the JSP editor and the navigator, and the DOMINO database is a plugin such as IBM LOTUS DOMINO Toolkit for WEBSPHERE Studio. JSP content 24 in the JSP editor window 20 shows the source code view of a JSP page with some HTML structure. The navigator window 28 is used to select which file that is displayed in the editor pane 20. The DOMINO window displays the structure of a previously selected DOMINO database, and from the DOMINO window elements of the DOMINO structure may be inserted by inserting means such as “drag and drop” into the source window 20 of the JSP editor whereby the expansion to JSP tags occurs.

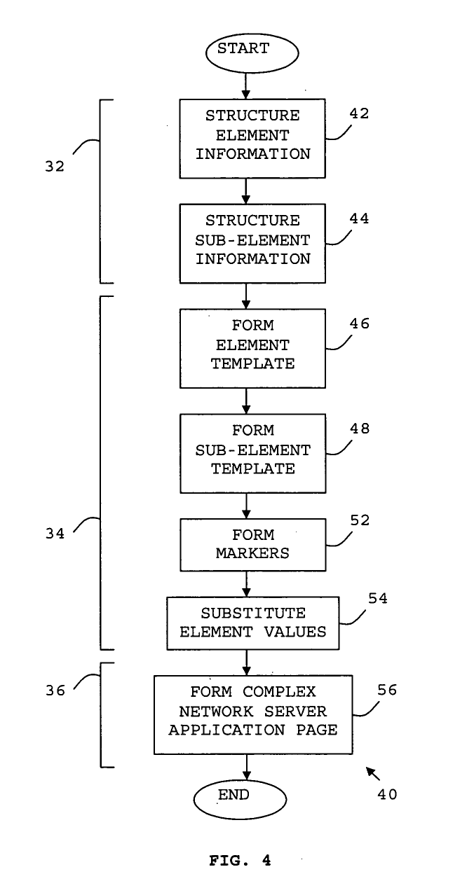

FIG. 3 is another screen shot 30 showing a graphical representation of JSP editor window 20 with JSP editor content 25 of the JSP source file after the insertion or drag and drop operation described above. For example, with WSSD, JSP editor 20 and DOMINO database 26, the drag and drop may be performed to the source window or an insertion procedure may be performed from the element of the DOMINO structure that produces a menu with an option to insert the element in the DOMINO database into the source code. In this example, the listed elements (“DateAcquired”, “Comments”, “Media”, “Artist”, “Title”, “Category”) in the DOMINO database 26 of FIG. 2 are inserted into the JSP editor 20 resulting in JSP content 25 of FIG. 3.

With this configuration, a functionality is achieved at a further level of abstraction from tag libraries, allowing aggregations to be used as easily as each individual tag, while preserving the flexibility, functionality and power of the original tag library.

In a particular implementation, an embodiment of the present invention may be effected by aggregation for creation of objects containing custom tags in JSP through following input, process and output stages as indicated in the flow chart of a method 40 embodying the invention in FIG. 4. The input stage 32 structures element information 42 and sub-element information 44. The structuring of the information may be a representation of the design of a DOMINO database application. The structure design contains a number of elements such as views, forms and other constructs, where each element of the design contains a number of sub-elements, which may be sources of information like items, sub-forms, fields, or the like. Essentially, in this embodiment the information is structured as a hierarchical tree. Of course, the information may be structured in other ways such as linear lists, directed graphs, or the like.

The process stage 34 forms the element template 46 and the sub-element template 48. The template exists to represent each element type. Markers are formed 52 in the templates, and the hierarchical tree structure that represents the input is traversed. When the corresponding template that matches the element type is found, the element values are substituted 54 into the template text where the markers indicate, and the template content is appended to the output.

The output stage 36 forms the complex network server application page 56, such as a complex JSP page. The complex JSP page is formed by aggregation of template content based on the hierarchical representation of the input.

A sample implementation is to aggregate the DOMINO custom tags for a DOMINO view in three templates: The view template contains:

<%--Single sign-on (SSO) support allows Web users to authenticate once when accessing Web resources across multiple WAS servers. To enable Single Sign On (SSO), uncomment the line of code which sets the user variable equal to *webuser, and comment out the line of code containing the explicit username and password.--%>

```
<%-- <$(tagprefix):view viewname=”$(viewname)”
dbserver=”$(servername)” dbname=”$(databasepath)”
user=”*webuser” $(hostname)> --%>
<$(tagprefix):view viewname=”$(viewname)”
dbserver=”$(servername)” dbname=”$(databasepath)” user=”<%=
username %>” password=”<%= password %>”$(hostname)>
  <table>
    <tr>
$(viewtitles) </tr>
    <$(tagprefix):viewloop>
      <tr>
$(viewitems) </tr>
    </$(tagprefix):viewloop>
  </table>
</$(tagprefix):view>
```

The keys underlined allow for substitution, either as known keywords, for example “$(tagprefix)” refers to the ID associated with the particular tag library, or as nested calls to other templates, for example “$(viewtitles)” or “$(viewitems)”.

The view titles template may contain:

<td> $(startattr) $(columntitle) $(endattr) </td>

The view items template may contain:

<td> $(ifcatbegin) $(startattr) <DOMINO:viewitem
col=”$(columnnumber)”/> $(endattr) $(ifcatend) </td>

The keys underlined may be either replaced in the generated JSP source code by values from the initial structure, for example from the DOMINO database, or used to drive further processing, for example the inclusion of another template file at that point.

A further sample uses a form template and a form item template to construct the JSP tagging to allow the viewing of a document using a DOMINO form.

Form Template may contain:

```
<%--Single sign-on (SSO) support allows Web users to
authenticate once when accessing Web resources across
multiple WAS servers. To enable Single Sign On (SSO),
uncomment the line of code which sets the user variable
equal to *webuser, and comment out the line of code
containing the explicit username and password. --%>
<%-- <$(tagprefix):form name=”formname”
dbname=”$(databasepath)” dbserver=”$(servername)”
$(hostname) user=”*webuser” schema=”$(formname)”> --%>
<$(tagprefix):form name=”formname” dbname=”$(databasepath)”
dbserver=”$(servername)” $(hostname) user=”<%= username %>”
password=”<%= password %>” schema=”$(formname)”>
      <table>
$(formitems) </table>
</$(tagprefix):form>
The Form Item Template may contain:
<tr>
            <td>$(fieldname)</td>
            <td><DOMINO:input name=”$(fieldname)”
type=”$(datatype)”/></td>
      </tr>
```

Similarly, as discussed above, the keys underlined allow for substitution, either as known keywords, or as nested calls to other templates. The keys underlined may be either replaced in the generated JSP source code by values from the initial structure, for example from the DOMINO database, or used to drive further processing, for example the inclusion of another template file at that point.

It will be understood that the system and method described above for aggregation objects containing custom tags in a JSP provide the advantage of facilitating building of complex JSP pages. While only specific embodiments of the invention have been described herein, it will be understood that various change or modifications may be made without departing from the scope of the invention.

1. A system for creation of a network server application page, comprising:
means for representing information in a structure having at least one element, each element having at least one sub-element;
means for processing a template representing each element and sub-element, the template having a marker, the means for processing for searching the structure for a corresponding template that matches the marker in the template, and substituting into the template an element value where the marker indicates; and
means for aggregating the template based on the structure.

2. A system of claim 1 wherein the means for representing information comprises a data structurer for representing the information in the structure, the means for processing the template comprises a data processor, and the means for aggregating comprises an aggregator for aggregating the template.

3. A system of claim 1 wherein the structure is a hierarchical format.

4. A system of claim 1 wherein the network server application page is JAVA server page (JSP).

5. A system of claim 1 wherein the element is one of:
a view, and
a form.

6. A system of claim 1 wherein the sub-element is selected from the group consisting of a subform, an item, a field.

7. A system of claim 2 wherein the data structurer is a DOMINO database.

8. A system of claim 2 wherein the data processor is a JSP editor.

9. A method for creation of a network server application page, comprising:
representing information in a structure having at least one element, each element having at least one sub-element;
processing a template representing each element and sub-element, the template having a marker;
searching the structure for finding a corresponding template that matches the marker in the template;
substituting into the template an element value where the marker indicates; and
aggregating the template based on the structure to form the network server application page.

10. A method of claim 8 wherein the structure is a hierarchical format.

11. A method of claim 8 wherein the network server application page is a JAVA server page (JSP).

12. A method of claim 8 wherein the element is one of:
a view, and
a form.

13. A method of claim 8 wherein the sub-element is selected from the group consisting of a subform, an item, a field one of.

14. A method of claim 8 wherein the step of representing the information is performed by a data structurer wherein the data structurer is a DOMINO database.

15. A method of claim 8 wherein the step of processing is performed by a data processor wherein the data processor is a Java server page (JSP) editor.

16. A computer program product for creating a network application page comprising a computer useable medium having a computer readable program code means embodied in the medium for causing creation of a network server application page, the computer program product comprising:
a computer readable program code means for representing information in a structure having at least one element, each element having at least one sub-element,
a computer readable program code means for processing a template representing each element and sub-element, the template having a marker;
a computer readable program code means for searching the structure for a corresponding template that matches the marker in the template;
a computer readable program code means for substituting into the template an element value where the marker indicates; and
a computer readable program code means for aggregating the template based on the structure to form the network server application page.

17. A computer programmed to perform a method of creating a network application page, the method comprising:
representing information in a structure having at least one element, each element having at least one sub-element,
processing a template representing each element and sub-element, the template having a marker;
searching the structure for a corresponding template that matches the marker in the template;
substituting into the template an element value where the marker indicates; and
aggregating the template based on the structure to form the network server application page.
